(19) United States
(12) Patent Application Publication
(10) Pub. No.: US 2005/0236744 A1
(43) Pub. Date: Oct. 27, 2005

(54) Method and apparatus for forming bathliners

(76) Inventor: Tilio Camodeca, North Riverside, IL (US)

Correspondence Address: KNECHTEL DEMEUR & SAMLAN;ATTN: ALAN B. SAMLAN, 222 S. RIVERSIDE, SUITE 1410, CHICAGO, IL, 60606, US

(21) Appl. No.: 10/832,714

(22) Filed: Apr. 27, 2004

(51) Int. Cl. B29C 51/10

(52) U.S. Cl. 264/553; 425/388

(57) ABSTRACT

A bathliner forming machine that forms bathliners for conventional bathtubs in use today. The bathliner forming machine comprises a bathtub mold, a skirt mold, a conveyance means, a liner sheet, and an oven. The conveyance means comprises a clamping frame for securing and retaining the liner sheet and a rolling frame for moving the clamping frame into and out of the heating machine. The clamping frame is also uniquely designed to bend the heated, malleable liner sheet over the skirt mold for creating the bathtub and skirt sections that form a completed bathliner. The oven is utilized to heat the liner sheet until it is malleable enough so that it can be formed over the bathtub mold and the skirt mold.

### I. FIELD OF THE INVENTION

The present invention relates to bathliners and, more particularly, to the method and apparatus for forming bathliners.

### II. DESCRIPTION OF THE PRIOR ART

Liners for bathtubs, also referred to as bathliners, have been around for many years. After years of use, the surface of a bathtub may become damaged by abrasions, chips, discoloration, rust, and cracks. As a result, the useful life of the bathtub will end unless the bathtub is refurbished or covered with a liner. The liner provides a durable finish that covers the bathtub and provides a new surface over the bathtub.

One such device for replacing a bathliner is disclosed in U.S. Pat. No. 5,814,270 entitled “Apparatus And Method For The Formation of A Bathtub or Shower Stall Liner.” This patent discloses a bathtub or shower stall liner vacuum forming system for the forming of a liner to be positioned over an existing bathtub. This system, however, requires complex steps and the interaction of many components using multiple and necessary steps to create or form a bathtub or shower stall liner. Applicant's invention, on the other hand, provides a less complex device that is more efficient for forming such bathliners.

Thus, there is a need and there has never been disclosed Applicant's unique method and apparatus for forming bathliners.

### III. SUMMARY OF THE INVENTION

The present invention is a bathliner forming machine that forms bathliners for most conventional bathtubs in use today. The bathliner forming machine comprises a bathtub mold, a skirt mold, a conveyance means, a liner sheet, and an oven. The conveyance means comprises a clamping frame for securing and retaining the liner sheet and a rolling frame for moving the clamping frame into and out of the heating machine. The clamping frame is also uniquely designed to bend or position the liner sheet for creating the bathtub and skirt sections that form a completed bathliner. The oven is utilized to heat the liner sheet until it is malleable so that it can be formed over the bathtub mold and skirt mold.

### IV. BRIEF DESCRIPTION OF THE DRAWINGS

The Description of the Preferred Embodiment will be better understood with reference to the following figures:

FIG. 1 is a right side perspective view of the Applicant's bathliner forming machine, prior to supplying of the liner sheet.

FIG. 2 is a front perspective view, with portions removed, of the bathliner forming machine and, in particular, depicting the detachable liner frame in the formation position.

FIG. 3 is a left side perspective view, with portions removed, of the bathliner forming machine and, in particular, illustrating the controls of the machine.

FIG. 4 is a front perspective view, with portions removed, of the bathliner forming machine and, in particular, illustrating the liner sheet secured into the horizontal flat or pre-heating position within the clamping frame.

FIG. 5 is a left side perspective view, with portions removed, of the bathliner forming machine and, in particular, illustrating the conveyance means positioning the liner sheet within the oven to be heated.

FIG. 6 is a left side perspective view, with portions removed, of the clamping frame holding the liner sheet in the formation position adjacent the bathtub skirt mold.

FIG. 7 is a right side perspective view of the bathliner formed by Applicant's bathliner forming machine.

### V. DETAILED DESCRIPTION OF THE PREFERRED EMBODIMENT

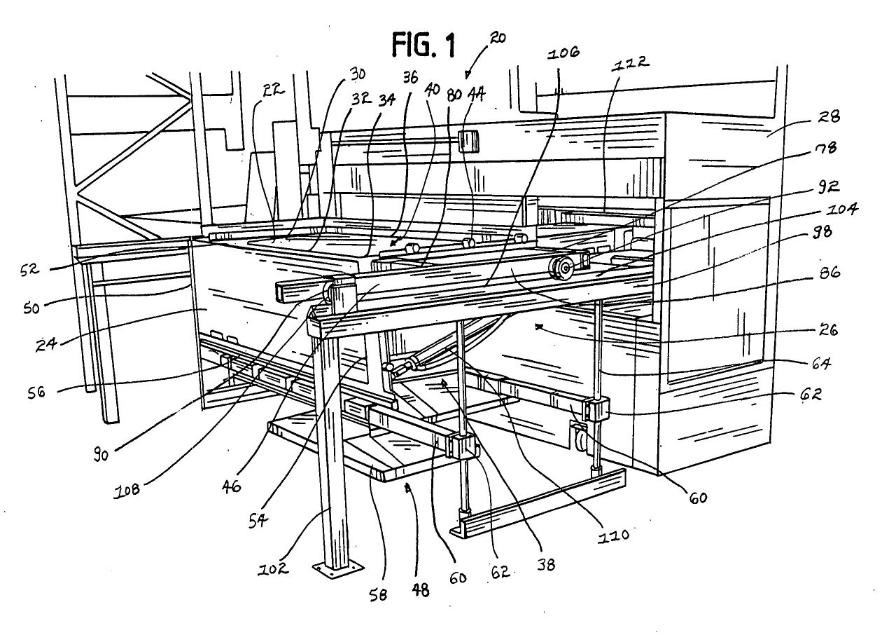

Turning first to FIG. 1, there is illustrated Applicant's bathliner forming machine 20. The bathliner forming machine 20 comprises a bath tub mold 22, a skirt mold 24, a conveyance means 26, and an oven 28.

The bath tub mold 22 is generally rectangular in shape and has four sides 30, 32, 34, and 36, a bottom 38, and an opening 40 centrally located between all the sides 30-36 and the bottom 38. In the preferred embodiment, the height and length of the sides 30-36, the bottom 38, and opening 40 form the size of any conventional bathtub in use today. The bath tub mold 22 is preferably made of cast iron or steel.

An adjustable lift 48 having a vertical stand 58 and arms 60 is used to raise and lower the bathtub mold 22 to place and hold it into proper position with respect to the conveyance means 26, discussed later in the specification. The arms 60 are comprised of end caps 62 with circular passageways for securing the adjustable lift 48 to corresponding vertical support members 64 of the bathliner forming machine 20. The vertical support members 64 provide stabilization for the adjustable lift 48 and, when the adjustable lift 48 is being vertically raised and/or lowered, assists in alleviating the adjustable lift 48 from tilting or otherwise becoming unstable due to the weight of the bath tub mold 22.

Located adjacent to the side 32 of the bath tub mold 22 is the skirt mold 24. The skirt mold 24 is positioned vertically and parallel to side 32 of the bath tub mold 22. Preferably, the skirt mold 24 is rectangular in shape and has a smooth, flat surface having skirt sides 50, 52, 54, and 56. In the preferred embodiment, the skirt side 52 is in the same horizontal plane as the tops of all the sides 30-36 of the bath tub mold 22 and has a length which is slightly larger than the length of side 32 of bath tub mold 22. The skirt mold 24 is preferably made of a metal such as aluminum or steel.

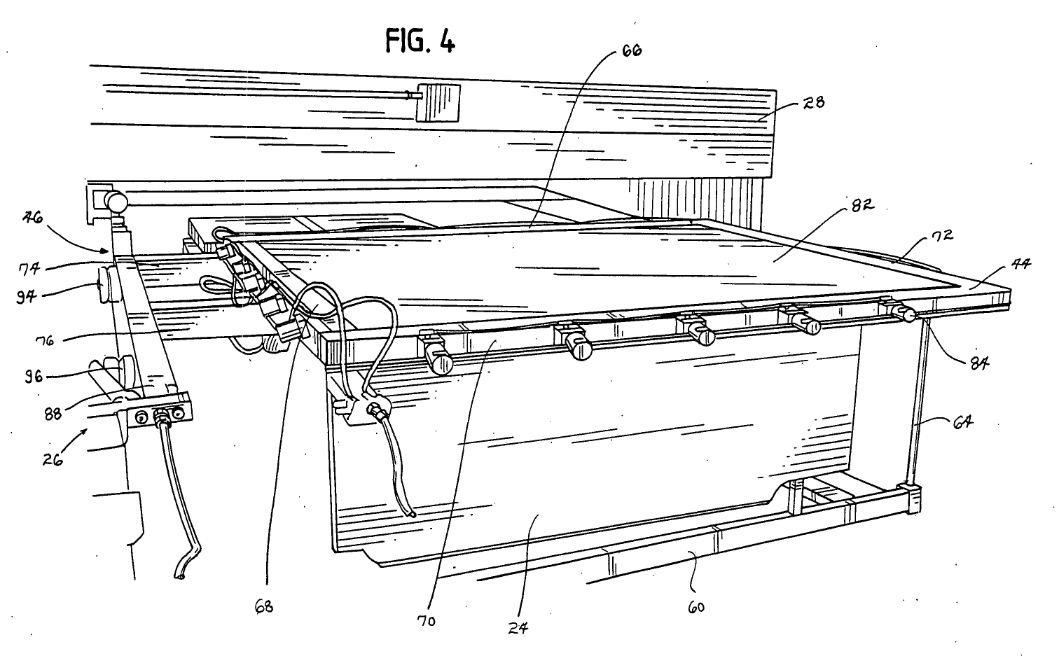

The conveyance means 26 comprises a clamping frame 44 and a rolling frame 46. The clamping frame 44 is more clearly illustrated in FIG. 4. The purpose of the clamping frame 44 is threefold: (1) to retain and hold a liner sheet 82 in proper position within the clamping frame 44 for preparation of the liner sheet 82 for heating in the oven 28, (2) to properly place the liner sheet 82 over the bath tub mold 22 for creating the bath tub section of the bathliner apparatus, and (3) convert from being a section in a flat horizontal plane into two separate and distinct sections with each section perpendicular to one another for coacting to properly bend the liner sheet 82 over the skirt mold 24 thereby creating the skirt section of the bathliner apparatus. The clamping frame 44 comprises frame sides 66, 68, 70, and 72. Sides 66-72 are chosen to accommodate the size of the bathliner for the desired bathtub.

The clamping frame 44 is comprised of clamps 84 that extend around the entire circumference of the clamping frame 44. The clamps 84 are used to retain and hold the liner sheet 82 in the proper position within the clamping frame 44. The clamps 84 are equally spaced from adjacent clamps 84 around the entire circumference of the clamping frame 44 to securely retain and hold the liner sheet 82 in the proper position within the clamping frame 44. As depicted, the liner sheet 82 is retained and held by the clamping frame 44 in the “flat” or “pre-heating” horizontal position. The clamping frame 44 is secured to the rolling frame 46 by bridging sections 74 and 76, 78 and 80 (FIG. 1). Preferably, bridging sections 74-80 are made of steel.

The liner sheet 82 is preferably made of a durable acrylic material. The use of durable acrylic in bathliners provides a surface that will not chip, dent, crack or peel. The durable acrylic is also completely colorfast as it will not stain, yellow, or fade and provides a high gloss finish. Also, the bathliners do not provide grout lines and, therefore, can be cleaned or maintained easily with general household cleaners.

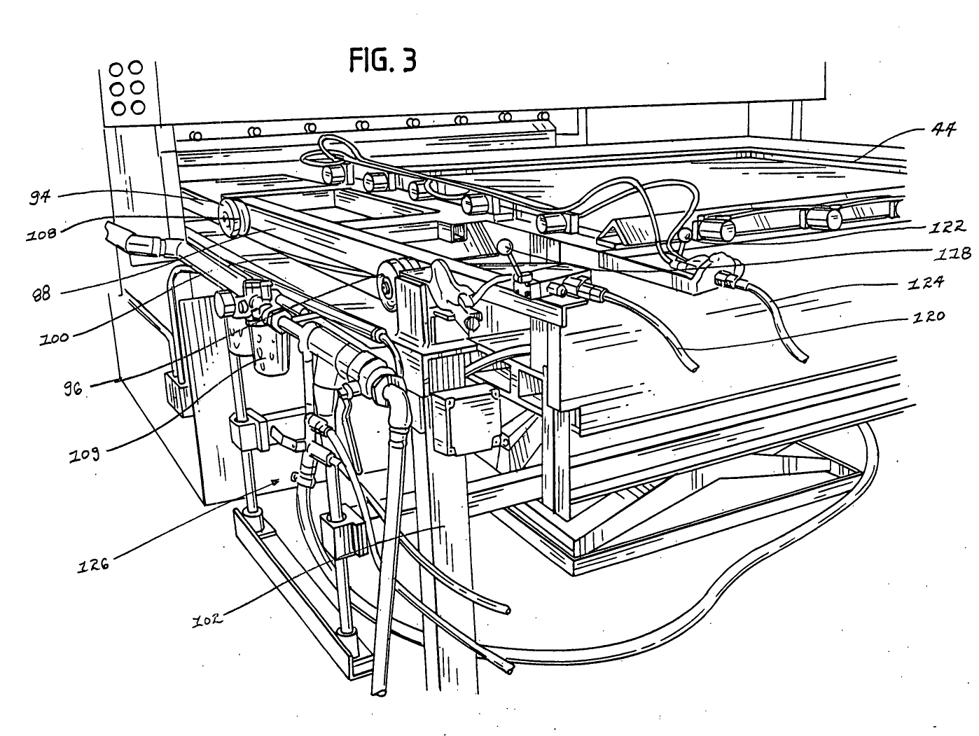

The purpose of the rolling frame 46 is to transport the liner sheet 82 and the clamping frame 44 into and out of the oven 28. The rolling frame 46 is best illustrated in FIGS. 1 and 3. The rolling frame 46 is comprised of beams 86, 88 and wheels 90, 92, 94, and 96. The wheels 90, 92 are mounted to beams 86 and wheels 94, 96 are mounted to beam 88. Secondary beams 98 and 100 are each supported by a vertical pillar 102, on one end, and the oven 28, on the other. The secondary beams 98 and 100 serve two purposes: (a) to provide structural support for the conveyance means 26, and (b) to provide the means for permitting the rolling frame 46 to move into and out of a chamber 112 in the oven 28. The means for permitting the rolling frame 46 to move into and out of a chamber 112 in the oven 28 begins with an A-shaped crest track 104 (FIG. 1). The crest track 104 provides a pointed rail 106 at the top of the crest track 104. The wheels 90-96 are provided with a V-shaped crevice 108, also illustrated in FIG. 3, that reciprocally corresponds to the pointed rail 106 of the A-shaped crest track 104. In this manner, the rolling frame 46, using the wheels 90-96 and the A-shaped crest track 104, may be freely moved into and out of the oven 28. Alternatively, any other means for moving the rolling frame 46 may be used provided that the alternate means is not adversely affected by the heat from the oven 28.

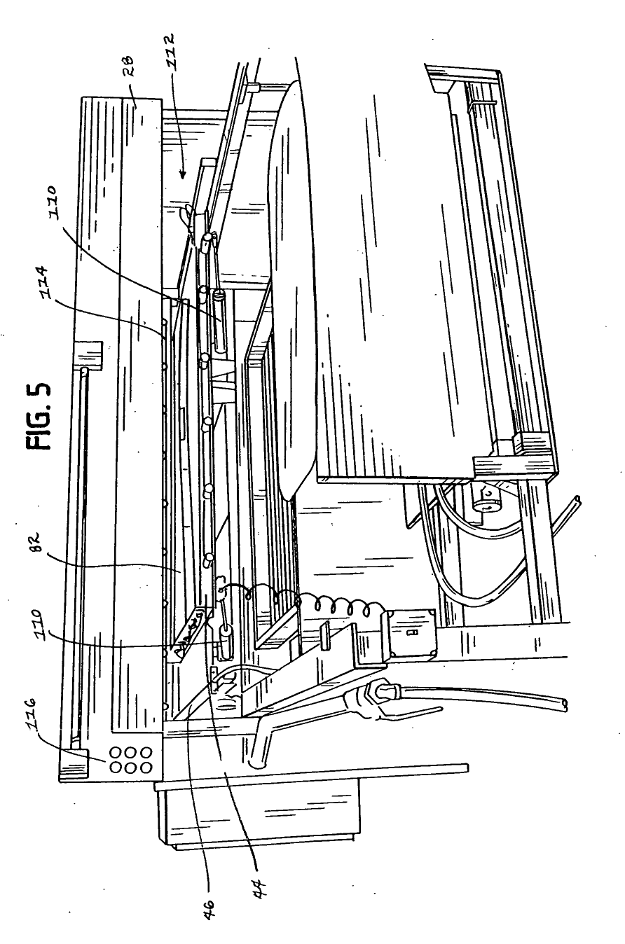

A pneumatic or hydraulic drive 109 provides the means for moving the rolling frame 46 into and out of the oven 28. Alternatively, a chain or worm gear drive can be used. The drive 109 moves the frame 46 from a first position outside the oven 28 such as seen in FIG. 1, to a second position inside the chamber 112 of the oven 28 such as seen in FIG. 5. The pneumatic or hydraulic drive 109 is not illustrated in detail as the drive systems are well known in the art.

As illustrated in FIG. 3, a pneumatic control 118 and pneumatic hoses 120 are connected to and operate the pneumatic cylinder 110. Likewise, the clamping frame 44 is operated by a pneumatic control 122 and pneumatic hoses 124. The pneumatic controls 118, 122 and the pneumatic controls 120, 124 are regulated by a pneumatic control center 126.

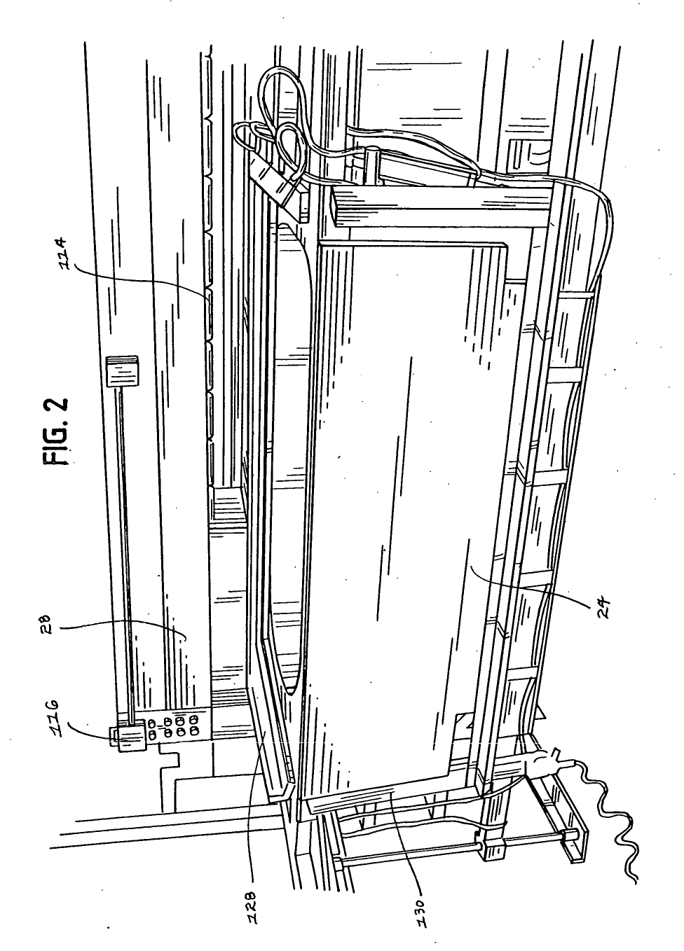

The oven 28 is preferably a heating type oven. The chamber 112 of the oven 28 is provided with heating elements 114 (FIG. 2). The heating elements 114 are regulated by a control panel 116 located on the front of the oven 28. In the preferred embodiment, the purpose of the oven is to uniformly heat the liner sheet 82 to a temperature at which the liner sheet 82 becomes malleable. In the preferred embodiment, the liner sheet 82 becomes malleable enough to form the finished bathliner when the temperature reaches at least three hundred twenty-six degrees (326°).

In use, the bathliner forming machine 20 is operated as follows. Beginning with FIG. 1, the bathtub mold 22 is positioned, using the adjustable lift 48, such that the top of the bathtub mold 22 is slightly below the bottom of the clamping frame 44. The skirt mold 24 is likewise positioned adjacent to the side 32 of the bathtub mold 22.

The liner sheet 82 is then, as illustrated in FIG. 4, inserted into and positioned within the clamping frame 44. The liner sheet 82 is secured into position using the clamps 84 which are operated by the pneumatic control 122 and pneumatic hoses 124, as illustrated in FIG. 3. The clamping frame 44 is in the flat horizontal position relative to the top of the bathtub mold 22 and perpendicular to the skirt mold 24. This position of the liner sheet 82 is referred to as the “pre-heating” position as the bathliner forming machine 20 is ready to heat the liner sheet 82.

The rolling frame 46 is then, as illustrated in FIG. 5, rolled into the chamber 112 of the oven 28. As the clamping frame 44 is secured to the rolling frame 46 in the same horizontal plane using the bridging sections 74 and 76 (FIG. 4) and bridging sections 78 and 80 (FIG. 1), the clamping frame 44 is likewise pulled into the chamber 112 of the oven 28. The rolling frame 46 is inserted into the oven 28 using the pneumatic drive 109 until the rolling frame 46 and the clamping frame 44 are fully inserted into and within the chamber 112 of the oven 28. Alternatively, the rolling frame 46 can be manually pushed into and pulled out of the oven 28. In this manner, the top and bottom surfaces of the liner sheet 82 are completely within the chamber 112 of the oven 28.

The oven 28, using the control panel 116 (see also FIG. 2) heats the liner sheet 82 using the heating elements 114. The heating elements 114 are positioned above and below the liner sheet 82 at a sufficient distance to uniformly heat the liner sheet 82 without burning or over heating any portions of the liner sheet 82. It is contemplated that the oven 28 may alternatively use any conventional heating system such as natural gas, radiant, or electrical resistance.

Once the liner sheet 82 reaches a sufficient temperature to become malleable, the rolling frame 46 is removed from the chamber 112 of the oven 28, thereby, removing the clamping frame 44 and the malleable liner sheet 82 from the chamber 112 of the oven 28 and returning the clamping frame 44 to its original position.

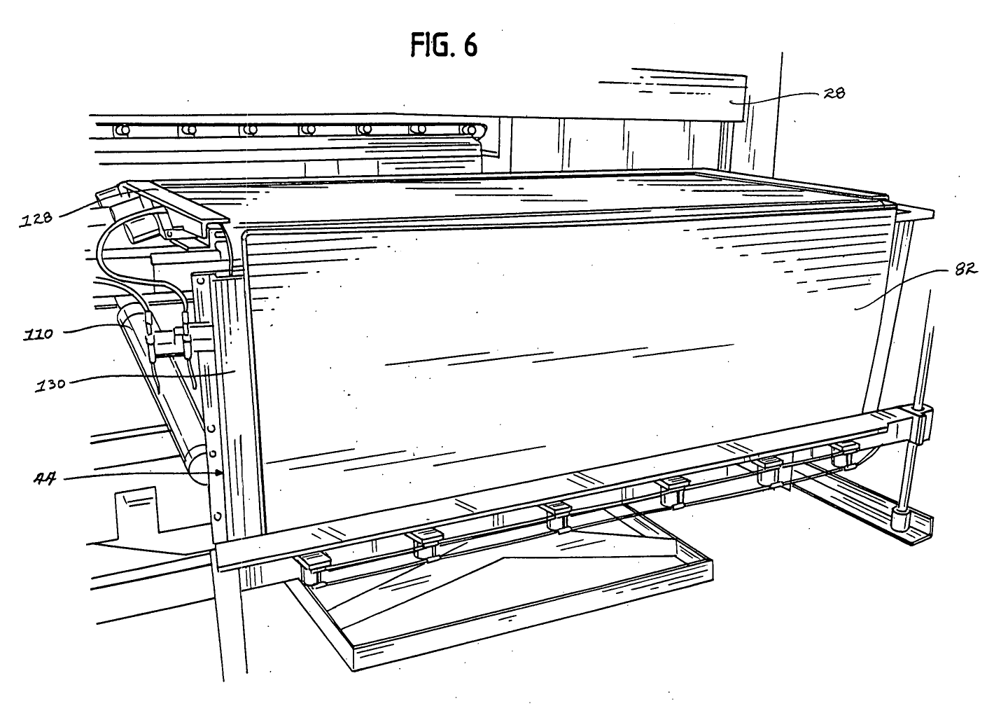

The clamping frame 44 is then, as illustrated in FIG. 4, split into a first section 128 and a second section 130. The first section 128 remains in the flat, horizontal position above the bathtub mold 22 with the liner sheet 82 covering the entire bathtub mold 22. The second section 130 is rotated downward through ninety degrees (90°) from a flat, horizontal position to a flat, vertical position parallel to the exterior surface of the skirt mold 24. A pneumatic cylinder 110 is connected to the second section 130 such that the pneumatic cylinder 110 controls the position of the second section 130 between the horizontal and vertical positions. For illustration purposes, FIG. 2 depicts the first section 128 and the second section 130 of the clamping frame 44 oriented at ninety degrees (90°) with respect to each other as it would appear without the liner sheet 82. FIG. 6 illustrates the liner sheet 82 when it is heated and bent over the exterior of side 32 of the bathtub mold 22 and positioned parallel to the exterior surface of the skirt mold 24. In this manner, the malleable liner sheet 82 covers the entire surface of both the bathtub mold 22 and the skirt mold 24.

The bathtub mold 22 and the skirt mold 24 are disposed with numerous air passageways positioned approximately two inches away from each other so as to facilitate the uniform drawing or vacuum of the malleable liner sheet 82 toward each respective mold. The means for drawing air through the air passageways in the bathtub mold 22 and the skirt mold 24 is by a hose and an electric pump (not illustrated) with sufficient power to create enough vacuum to pull air through the air passageways and into the hose thereby drawing the malleable liner sheet 82 toward the respective molds. Once substantially all of the air has been evacuated, the liner sheet 82 is intimately drawn against the bathtub mold 22 and skirt mold 24, respectively, and generally taken on the configuration of the interior surface of the bathtub mold including any specific openings in the bathtub such as an overflow outlet and/or drain.

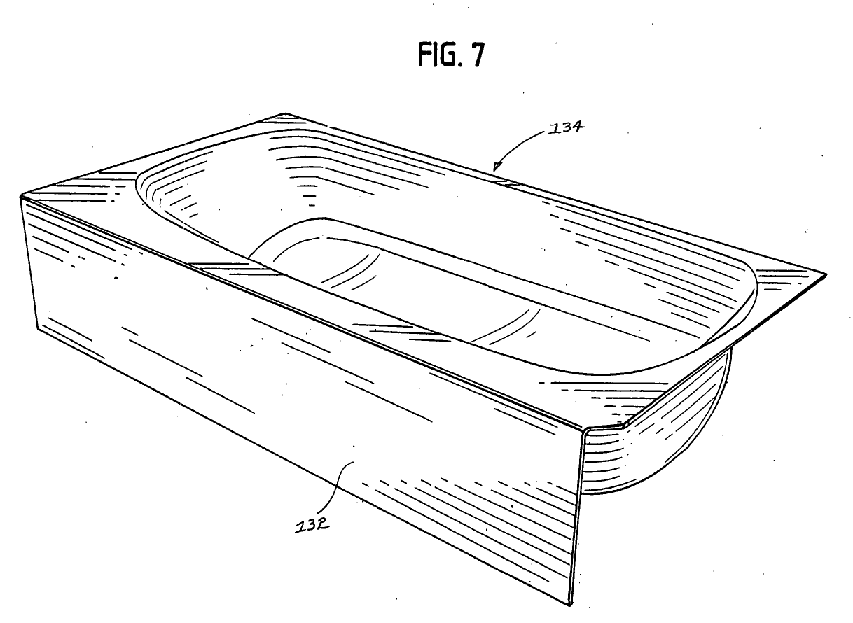

Once the liner sheet 82 is formed into the bathtub liner, the vacuum is turned off and the liner sheet 82 is cooled by forcing ambient air at a lower pressure over the liner sheet 82. This can be accomplished by conventional cooling fans. The air will cool the formed liner such that it may be removed from the bathtub mold forming a bathliner 134 as illustrated in FIG. 7. Excess flushing can be manually trimmed as necessary. The bathliner 134 may have a skirt 132 with various types of designs, shapes, or ornamentation to provide numerous designs.

Thus, there has been provided a unique method and apparatus for forming bathliners. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the appended claims.

1. A device for forming bathliners from a liner sheet, comprising:
a bathtub mold having four upstanding sides separated by a bottom and defining an opening located between the sides for forming a box shaped configuration;
a skirt mold vertically positioned adjacent to one of the upstanding sides of the bathtub mold;
means for heating the liner sheet for forming a malleable liner sheet;
a clamping frame for retaining the liner sheet in a substantially horizontal plane positioned above and adjacent to the opening in the bathtub mold and positioning the malleable liner sheet into engagement with both the bathtub mold and the skirt mold, the clamping frame having means for separating into a first section and a second section, the first section retaining a first portion of the malleable liner sheet in the horizontal plane in relation to the bathtub mold, the second section retaining a second portion of the malleable liner sheet and rotating to position the section portion of the malleable liner sheet in a substantially vertical plane and parallel to the skirt mold;
vacuum means for removing air from between the bathtub mold and the malleable liner sheet and from between the skirt mold and the malleable liner sheet; and
whereby, upon evacuating the air between the malleable liner sheet and both the bathtub mold and the skirt mold, the malleable liner sheet is drawn toward the bathtub mold and the skirt mold and upon cooling the malleable liner sheet to return it to a rigid state, a bathliner is formed.

2. The device of claim 1 and further comprising means for inserting and removing the clamping frame into and out of the means for heating the liner sheet.

3. The device of claim 2 wherein the means for inserting and removing the clamping frame into and out of the means for heating the liner sheet is a rolling frame.

4. The device of claim 3 wherein the rolling frame is comprised of a beam and a parallel secondary beam, the beam having wheels corresponding to an A-shaped crest track on the secondary beam thereby enabling the beam to traverse across the secondary beam and permitting the rolling frame to insert the clamping frame into the means for heating the liner sheet.

5. The device of claim 1 wherein the means for heating the liner sheet for forming a malleable liner sheet is an oven.

6. The device of claim 1 and further comprising an adjustable lift to position the bathtub mold into position in contact with the malleable liner sheet.

7. The method of claim 1 and further comprising a drive means connected to the second section of the clamping frame for pivoting the second section substantially ninety degrees from the horizontal.

8. A method for forming bathliners from a liner sheet, comprising the steps of:
retaining the liner sheet in a substantially horizontal plane on a bathliner forming machine;
providing means for heating the liner sheet;
heating the liner sheet to a desired elevated temperature so that the liner sheet becomes malleable;
providing a bathtub mold with a top surface of the mold in a substantially horizontal plane;
providing a skirt mold adjacent to the bathtub mold with a skirt mold surface in a substantially vertical plane;
positioning the heated malleable liner sheet in the horizontal plane above the top surface of the bathtub mold with a portion of the heated malleable liner sheet extending past the skirt mold,
bending the extended portion of the heated malleable liner sheet through a rotation angle to position the extended portion of the heated malleable liner sheet in the vertical plane adjacent to and parallel with the skirt mold surface;
evacuating the air between the heated malleable liner sheet and both the bathtub mold and the skirt mold thereby drawing the malleable liner sheet against the bathtub mold and the skirt mold surface for forming a bathliner; and
removing the bathliner from the bathliner forming machine.

9. The method of claim 8 and further providing a clamping frame for retaining the liner sheet in a substantially horizontal frame.

10. The method of claim 9 and further providing a movable frame for inserting the clamping frame into the means for heating the liner sheet.

11. The method of claim 10 and further providing rollers attached to the movable frame.

12. The method of claim 8 wherein the means for heating the liner sheet is an oven.

13. The method of claim 8 wherein the rotation angle is substantially ninety degrees.

14. The method of claim 8 and further comprising the step of cooling the malleable liner sheet after the step of evacuating the air between the malleable liner sheet and the bathtub mold and the skirt mold causing the malleable liner sheet to be rigid.
